(19) United States
(12) Patent Application Publication
(10) Pub. No.: US 2025/0167262 A1
(43) Pub. Date: May 22, 2025

(54) ELECTROCHEMICAL CELL COMPONENT, BIPOLAR PLATE, ELECTROCHEMICAL CELL AND ELECTROCHEMICAL SYSTEM COMPRISING SUCH A COMPONENT

(71) Applicant: Reinz-Dichtungs-GmbH, Neu-Ulm (DE)

(72) Inventors: Johann WALDVOGEL, Krumbach (DE); Oliver CLAUS, Laichingen (DE); Wilhelm KUHN, Tomerdingen (DE); Franz SCHWEIGGART, Pfaffenhofen (DE); Jonas LEISCHER, Neu-Ulm (DE)

(21) Appl. No.: 18/955,735

(22) Filed: Nov. 21, 2024

(30) Foreign Application Priority Data
Nov. 22, 2023 (DE) 20 2023 106 901.0

(51) Int. Cl. H01M 8/0297; C25B 9/19; C25B 9/60; H01M 8/0273; H01M 8/1004; H01M 8/18

(52) U.S. Cl. CPC H01M 8/0297; C25B 9/19; C25B 9/60; H01M 8/0273; H01M 8/1004; H01M 8/188

(57) ABSTRACT

The present disclosure relates to a component of an electrochemical cell, in particular a separator plate or a cell frame of an electrochemical cell. Furthermore, the present disclosure also relates to a bipolar plate, an electrochemical cell and an electrochemical system such as a fuel cell, an electrolyzer or a redox flow battery. The component comprises a first metallic layer. Adjacent to at least one free edge of the first metallic layer, the first metallic layer is at least in sections folded over on itself one or more times thereby forming one or more folded layers, thereby increasing the thickness of the component by one or more than one layer thickness of the first metallic layer.

### CROSS REFERENCE TO RELATED APPLICATION

This application claims priority to German Utility Model Application No. 20 2023 106 901.0, entitled “ELECTROCHEMICAL CELL COMPONENT, BIPOLAR PLATE, ELECTROCHEMICAL CELL AND ELECTROCHEMICAL SYSTEM COMPRISING SUCH A COMPONENT”, filed Nov. 22, 2023. The entire contents of the above-identified application is hereby incorporated by reference for all purposes.

### TECHNICAL FIELD

The present disclosure relates to a component of an electrochemical cell, in particular a separator plate or a cell frame of an electrochemical cell. Furthermore, the present disclosure also relates to a bipolar plate, an electrochemical cell and an electrochemical system such as a fuel cell, an electrolyzer or a redox flow battery.

### BACKGROUND AND SUMMARY

In electrochemical cells, especially for separator plates or cell frames, sealing structures are used, for example, to separate and seal off through-openings through the respective separator plate or cell frame to the outside or flow regions of media from one another. Sealing structures are also used to seal the entire layer from the outside. In electrochemical cells, high pressures occur between adjacent layers when they are pressed together to form a cell stack. As the compression process essentially involves static pressures and due to the high space requirements for the supply and discharge of reactants and end products as well as for regions with flow channels for media such as the electrochemical reaction region, i.e. the so-called flow region, in conventional systems, no compression limiters are usually used for the respective sealing structure for electrochemical cells such as fuel cells, for example. However, the disadvantage of this is that, for example, the channels embossed into the separator plate relax over time, and the distance to the neighboring plate is reduced in the region of the channels. As a result, the cross-section of the channel structures embossed into the respective layer is reduced. This also reduces the flow cross-sections of these channel structures, so that the passage of the same quantities of media requires a higher pressure, or smaller quantities of media are passed through. Depending on the medium, this significantly impairs the performance of the respective electrochemical cell or its cooling.

Another factor in the problem of relaxation of the formed layer material in the region of embossed channels is the fact that such metallic separator layers are usually manufactured from coil material, such as titanium, by stamping them out and then forming them into the respective component in a further stamping and/or embossing process.

The problem of relaxation of the formed layer material in the region of embossed channels is evident in components for electrolyzers, fuel cells and the like, as the separator layers are usually made of relatively soft materials. Due to the high fastening forces required to seal the high pressures, for example, in electrolyzers, and the use of relatively soft materials in the region of electrochemical cells, the relaxation of the embossed sealing structures plays a greater role than in other regions with lower pressures. This relaxation also plays a particularly important role for exclusively embossed deformation limiters, so that they cannot guarantee an effective limitation of the compression of neighboring sealing structures in the long term.

The present disclosure therefore provides a component of an electrochemical cell, for example, a separator plate or cell frame of an electrochemical cell, for example, for fuel cells, electrolyzers or redox batteries and bipolar plates used therein, in which the long-term stability of the dimensioning of the embossed flow channels and the long-term stability of the sealing elements is improved.

This object is at least partially solved by the component, the bipolar plate, the electrochemical cell, and the electrochemical system as described herein.

Such components, for example, separator plates or cell frames in electrochemical cells, have at least one metallic layer, for example, made of titanium.

According to the present disclosure, at least one free edge of the metallic layer, for example a circumferential edge of a through-opening or an outer edge of the metallic layer, is folded over on itself at least in sections, either once or several times, forming one or more fold layers. This increases the thickness of the component by a multiple of the thickness of the metallic layer. Such folds can be used as deformation limiters for neighboring channels, e.g. in flow regions or distribution regions of separator plates. They are also suitable as deformation limiters for adjacent sealing structures, for example embossed structures such as sealing beads or seals formed by elastomer injection molding. These sealing structures can be arranged in the same layer, which is folded over, or can also be arranged on other metallic layers or non-metallic layers adjacent to the metallic layer. For the function as a deformation limiter, the fold layer may be located adjacent to the channels or the sealing structure to be protected when viewed from above the respective first metallic layer.

The design of the component of an electrochemical cell according to the present disclosure makes it possible to increase the thickness of the first metallic layer to a multiple of the layer thickness in some regions and thus to provide a deformation limiter at different points, for example, in the region of free edges of the first metallic layer. In fact, the primary structures to be protected, such as flow channels or sealing structures, may also be located in this region, for example, around port openings/through-openings as well as on the outer edge of the respective first metallic layer. In this way, the deformation of such structures can be limited.

Components for electrochemical systems with a metallic layer are usually manufactured by a stamping/embossing process. The portion of material that is no longer required may not be completely removed during the punching process, but rather may be used in accordance with the present disclosure. For this purpose, for example, the material is not completely removed along the circumferential edge, e.g. of a media through-opening, but parts of the material are left behind during punching, which are then folded over onto the layer itself and thus increase the layer thickness by a multiple of the individual layer thickness, forming a folded edge as part of the circumferential edge of the media through-opening. Folding can be carried out once or several times, so that the total layer thickness can be increased not only by a factor of one, but also by a factor of several.

It is also possible to achieve such a thickening by at least twice the layer thickness by folding two different regions of the same free edge or different free edges onto each other. The folds, which are arranged one above the other at least in some regions when viewed from above the plane of the metallic layer, can be arranged on the same side of the metallic layer or on two different sides of the metallic layer.

An advantage of the design of the metallic layer according to the present disclosure is that no additional material is required for the deformation limiter and, on the other hand, a very stable compression limitation is achieved by the non-compressable material stacking. That is, the compression limitation is far more stable than when using a separate elastomer stopper or other embossed structures as compression limiters. A fold is also easy to produce, as only standard tool technology is required. The use of materials is also more sustainable, as parts of the same metallic layer that are not utilized in conventional systems are used to manufacture the deformation limiter.

Optionally, several folds can also be produced stacked on top of each other. It is also possible to create several folds adjacent to each other. The different folds can be on the same side of the metallic layer or on different sides of the same metallic layer.

With multiple folds in particular, it is possible that the folded edges for fold layers that are at least partially on top of each other when viewed from above the layer plane run parallel to each other and therefore the fold layers extend in opposite directions from the folded edge. It is also possible that the folded edges of the first fold layer and the second fold layer or other fold layers run at an angle α with α≠0°, optionally perpendicular to each other. Therefore the directions in which the fold layers extend from the respective folded edge are not parallel to each other, but are at an angle to each other, optionally are perpendicular to each other.

According to the present disclosure, the limitation of deformation by the respective fold layer can be further improved by introducing embossed structures into the fold layer, at least in certain regions, and/or by coating the fold layer. As embossed structures, wave-shaped or trapezoidal cross-sections, which are arranged several times in succession, may be particularly advantageous in order to reinforce the deformation limitation or also to further modify the fold layer, for example its elasticity or thickness.

The thickness of the fold layer can be reduced or increased by processing the region that forms a fold layer. For example, in a region where two fold layers lie directly on top of each other, one fold layer can have a thinned region so that the other fold layer lies on this thinned region.

The circumferential edge of a through-opening in the first metallic layer, for example, a through-opening for the supply or discharge of media, can be considered as a free edge on which such a fold can be produced. The fold according to the present disclosure can also be produced on the outer edge of the first metallic layer. The fold can advantageously be formed adjacent to the respective structure to be supported, e.g. a channel-containing flow region or a sealing structure.

The first metallic layer can also be coated, whereby the coating can be provided on one or two sides and/or for each of the coated sides in certain regions or over the entire surface. Elastomers, metals, metal oxides, nitrides, carbides and graphite may be suitable as coating materials, depending on the function of the respective coating on the metallic layer.

The present disclosure also relates to a bipolar plate for electrochemical cells, which has at least one separator plate (single-layer bipolar plate) or a plurality of separator plates (multilayer, for example, two-layer separator plate), wherein one or more of the separator plates of the bipolar plate are configured as a component according to the present disclosure. It is also possible to design a cell frame for a stack of electrochemical cells as a component according to the present disclosure.

In the case of two-layer separator plates, it is also possible within the scope of the present disclosure to fold both layers of the two-layer separator plate together, that is jointly, so that the fold layers of each of the two layers of the two-layer separator plate form a fold layer, the two fold layers coming to lie on top of one another, optionally directly. In this case, the two-layer separator plate forms a common, also two-layer, fold layer. However, it is also possible to fold the two layers of a two-layer separator plate separately. The separate folding can take place consecutively or simultaneously in such a way that the two fold layers come to lie on top of each other, optionally directly, or the two fold layers are separated from each other by a section of one of the two layers of the two-layer separator plates that is not folded over.

The present disclosure also relates to an electrochemical cell which has a component according to the present disclosure, for example, an electrochemical cell with a bipolar plate according to the present disclosure as described above or a cell frame according to the present disclosure and a membrane electrode unit.

According to the present disclosure, stacks of such electrochemical cells and bipolar plates are also encompassed by the present disclosure, for example, electrochemical systems such as fuel cells, electrolyzers, redox flow batteries and the like.

Some examples of components according to the present disclosure are given below, with identical or similar reference signs designating identical or similar elements, so that the description is not repeated if necessary.

Furthermore, the following examples contain a large number of advantageous features which further form the present disclosure and/or are optional, each of which can also individually further form the present disclosure according to claim 1. In particular, such further-forming and/or optional features may also be used together in any combination, both as combinations from the same example and as combinations of features from different examples.

### BRIEF DESCRIPTION OF THE FIGURES

FIG. 1 shows a top view of a separator plate of a bipolar plate.

FIG. 2 shows a cross-section along line A-A of FIG. 1.

FIG. 3 shows a top oblique view of a section of a variant in the region of line A-A.

FIG. 4 shows an example of a deformation limiter according to the present disclosure.

FIG. 5 shows an example of a deformation limiter according to the present disclosure.

FIG. 6 shows an example of a deformation limiter according to the present disclosure.

### DETAILED DESCRIPTION

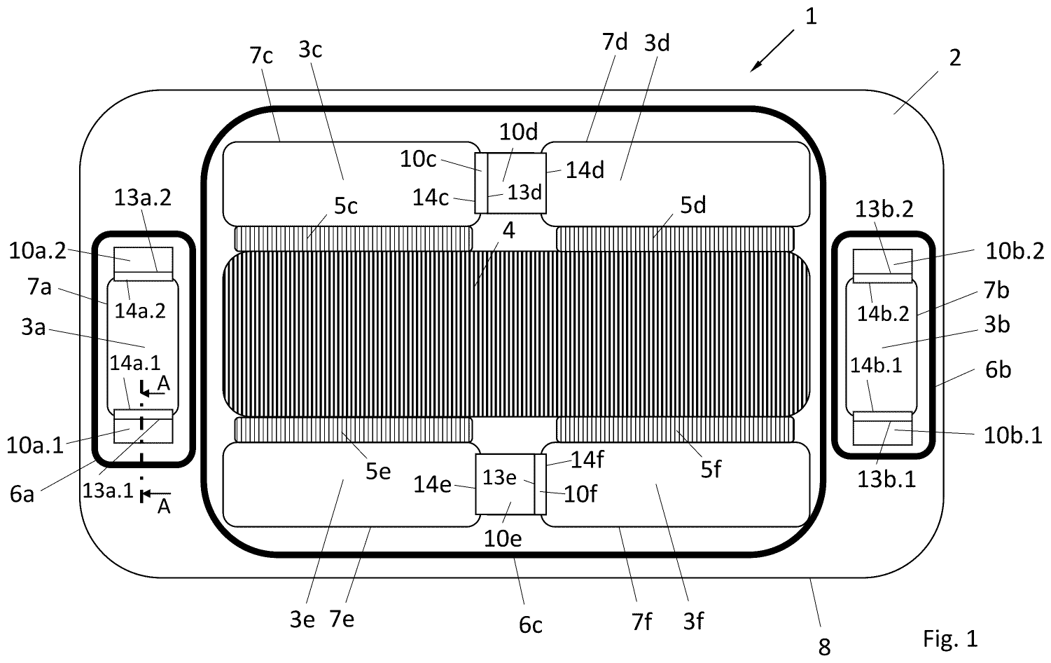

FIG. 1 shows a bipolar plate 1, in particular a top view of a separator plate of the bipolar plate 1 formed as a first metallic layer 2. Two such bipolar plates arranged adjacent to each other form an electrochemical cell together with a membrane electrode assembly (MEA) arranged between them. A fuel cell or an electrolyzer, for example, is formed from a large number of such bipolar plates or electrochemical cells.

The separator plate 2 has different regions within its outer edge 8 that provide different functions. On the one hand, an electrochemically active region, a so-called flow region 4, is located approximately in the center of the separator plate 2. Reactants are fed into this region and the electrochemical reaction is carried out.

Adjacent to this flow region 4 are through-openings 3a, 3b, 3c, 3d, 3e and 3f. When the separator plate is used in an electrolyzer, the through-openings 3a and 3b are used to discharge hydrogen from the flow region 4. The corresponding distribution structure or collection structure with flow channels between these openings 3a and 3b and the flow region 4 are located on the rear side of the separator plate 2, which is not shown in the view, and are not shown.

When the separator plate is used in an electrolyzer, the openings 3c and 3d are used to supply water to the flow region 4. For this purpose, distribution structures 5c and 5d are arranged between these openings 3c or 3d and the flow region 4, which contain flow channels that lead from the through-openings 3c or 3d to the flow region 4. In addition, through-openings 3e and 3f are provided, which are used to discharge oxygen and water when the separator plate is used in an electrolyzer. These through-openings 3e and 3f are also connected to the flow region 4 via distribution structures 5e and 5f, but now on the opposite side of the flow region 4 to the flow regions 5c and 5d. The distribution structures 5e and 5f also have channels that lead from the flow region to the through-openings 3e and 3f.

The flow region 4, distribution structures 5c, 5d, 5e, 5f and through-openings 3c, 3d, 3e and 3f are surrounded by a self-contained sealing structure 6c, which in this example is designed as an embossed sealing bead. However, it is also possible to use an elastomer scaling bead as scaling structure 6c.

The through-openings 3a and 3b are also each surrounded, in a closed manner around the respective through-opening, by sealing structures 6a (for the through-opening 3a) and 6b (for the through-opening 3b), which in the present example are each formed as an embossed scaling bead.

When pressing the bipolar plate 1 in an electrolyzer consisting of a large number of bipolar plates, the three regions shown are therefore each surrounded by a scaling bead 6a, 6b and 6c and sealed off from the outside. The sealing structures 6a, 6b and 6c are pressed together. The channel structures of regions 5c, 5d, 5e, 5f and 4 are also compressed to a certain degree. Over time, it is possible that the channel structures in regions 5 and 4 will be further compressed as the sealing structures relax. This reduces the cross-sections of the channels in the regions 5c, 5d, 5c, 5f and 4 and thus increases the resistance to the media flowing through, reduces the media throughput, and/or increases the energy required to pass media through the channels at a certain flow rate.

On the other hand, when a separator plate is densely packed with functional elements, as shown in FIG. 1, there is hardly any space for deformation limiters, which not only serve as deformation limiters for the sealing structures 6a, 6b and 6c, but also limit the deformation of the channels in the regions 4, 5c, 5d, 5e, 5f.

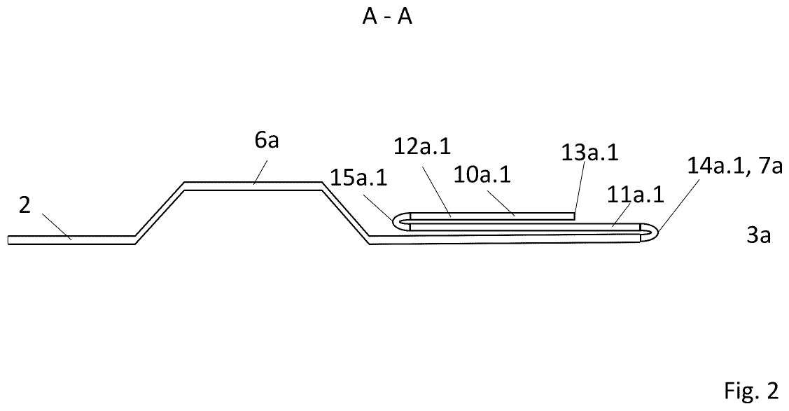

The present disclosure now proposes to apply a material region from the edges of the circumferential edges 7a to 7f of the through-openings 3a to 3f to the first metallic layer of the separator plate, forming terminal edges (outer edges of the respective fold at free-standing ends of the fold) 13a, 13b, 13d, and 13e and folded edges (edges at which the layer material is deflected towards the fold) 14a to 14f. Here, two fold layers 10a.1 and 10a.2 are formed from the circumferential edge 7a, as illustrated with the circumferential edge 7a of the through-opening 3a, which come to rest on the layer 2 itself and thus increase the thickness of the separator layer 2 in this region. As can be seen from FIG. 2 below, there may be a double fold in these fold regions, so that the thickness of the separator layer is actually tripled.

In the same way, two corresponding folds layers 10b.1 and 10b.2 are formed from the circumferential edge 7b of the through-opening 3b. A double fold is also formed between the passage regions 3c and 3d, in that a first fold layer 10c is formed from the circumferential edge 7c of the through-opening 3c and a second fold layer 10d is formed from the circumferential edge 7d of the through-opening 3d, the second fold layer 10d coming to lie at least partially on the first fold layer 10c.

Similarly, two fold layers 10e and 10f are also formed between the through-openings 3e and 3f from the circumferential edges 7e and 7f of the through-openings 3e and 3f, which are at least partially arranged on top of one another.

FIG. 2 shows a cross-section through the metallic layer 2 of FIG. 1 along the line A-A. The scaling bead 6a is arranged adjacent to the through-opening 3a, which protrudes with its bead roof towards the observer in FIG. 1. At the circumferential edge 7a of the through-opening 3a, the metallic layer of the separator plate 2 is folded over on itself twice, forming two fold layers 11a.1 and 12a.1 with folded edges 14a.1 and 15a.1. The edge of the metallic layer 2 and the fold 12a.1 forms a terminal edge 13a.1. The folded edge 14a.1 in the region of the fold 11a.1 forms the circumferential edge 7a of the through-opening 3a. As the fold layers 11a.1 and 12a.1 triple the thickness of the separator plate, these two fold layers form a very stable, non-compressible deformation limiter for the sealing bead 6a and adjacent flow channels.

The deformation limiters 10a.2, 10b.1 and 10b.2 in FIG. 1 are formed in the same way, so that their description is not repeated here.

The deformation limiters between the through-openings 3c and 3d or 3e and 3f are formed differently. These deformation limiters consist of two fold layers 10c and 10d, or 10e and 10f. Since the deformation limiter with the fold layers 10c and 10d between the openings 3c and 3d is designed in the same way as the deformation limiter with the fold layers 10e and 10f between the openings 3e and 3f, only the deformation limiter between the openings 3c and 3d is described in more detail below.

This deformation limiter is formed by two fold layers 10c and 10d. The fold layer 10c is folded over from the circumferential edge 7c of the opening 3c onto the metallic layer of the separator plate 2. The fold layer 10d is then folded over from the circumferential edge 7d of the through-opening 3d onto the fold layer 10c. This means that the two fold layers 10c and 10d lie on top of each other on the metallic layer 2, thereby tripling the thickness of the metallic layer 2 in this region. The outer, freestanding edge of the fold layer 10c lies between the metallic layer of the separator plate 2 and the fold layer 10d, and is not visible in FIG. 1. In contrast, the terminal edge 13d, which is the outer, freestanding edge of the fold layer 10d, lies above the fold layer 10c. The two fold layers 10c and 10d are folded over to the same side of the metallic layer 2, but could also be folded over to different sides of the metallic layer 2.

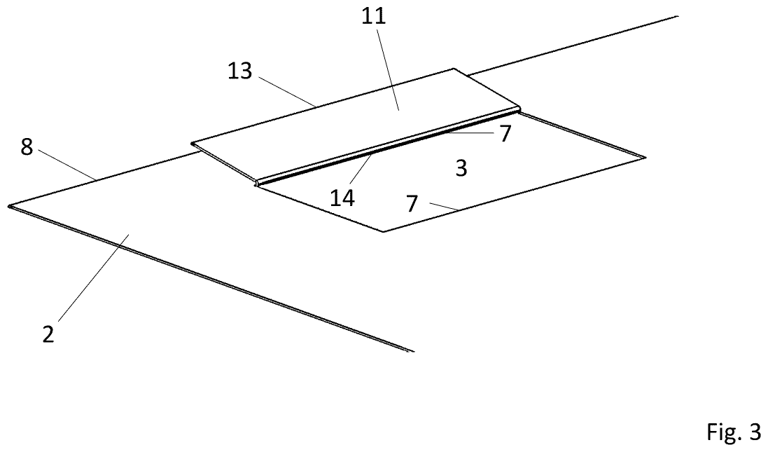

FIG. 3 shows a simplified version of the separator plate 2 in an oblique view around a through-opening 3. To form a deformation limiter for adjacent channels or sealing structures (not shown in FIG. 3), the metallic layer 2 is folded over on itself along the folded edge 14 to form a fold layer 11 with a terminal edge 13. This leads to a doubling of the thickness of the separator plate 2 in the region of the fold layer 11 and thus to a deformation limitation for neighboring structures.

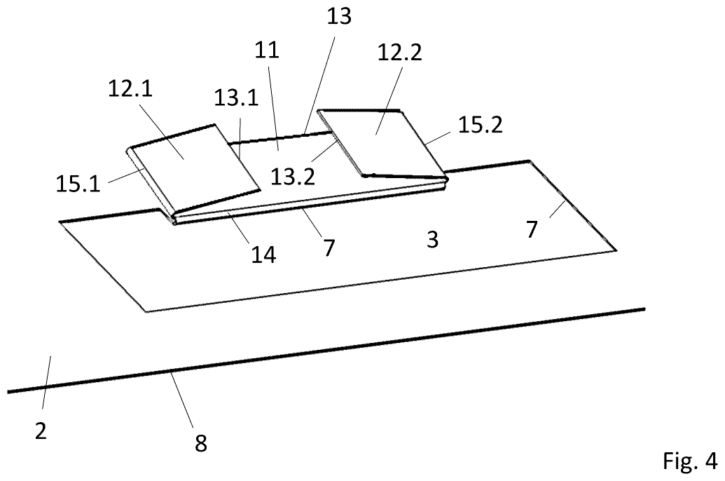

FIG. 4 shows a further variant of a deformation limiter according to the present disclosure in a separator plate 2. As previously shown in FIG. 3, a first fold layer 11 of the material recessed by the through-opening 3 is folded over onto the first metallic layer 2 along the circumferential edge 7 of the through-opening 3 and along a folded edge 14. The fold has an elongated shape that follows the elongated shape of the through-opening 3. In contrast to FIG. 3, the longitudinal ends of the fold layer 11 are now folded over onto the fold layer 11 along folded edges 15.1 and 15.2, forming further fold layers 12.1 and 12.2. These further fold layers 12.1 and 12.2 have a terminal edge 13.1 or 13.2 and folded edges 15.1 and 15.2 as layer ends, which run in a perpendicular direction to the terminal edge 13 of the first fold layer 11. This means that the direction in which the fold layer 12.1 extends from the folded edge 15.1 to the terminal edge 13.1, and the direction in which the fold layer 12.2 extends from the folded edge 15.2 to the terminal edge 13.2, is perpendicular to the direction in which the fold layer 11 extends from the folded edge 14 to the terminal edge 13.

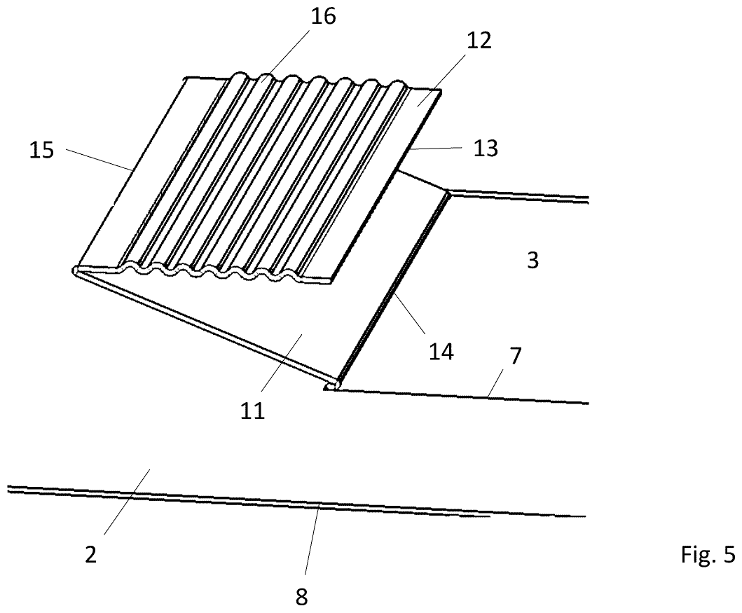

FIG. 5 shows another example of a metallic layer 2 of a separator plate in an oblique view in section. A double fold with a first fold layer 11 and a second fold layer 12 is formed from the material of the separator plate 2 cut out to form the through-opening 3. The first fold layer 11 has a folded edge 14, which in its region forms a section of the circumferential edge 7 of the through-opening 3. The second fold layer 12 has a folded edge 15 and a terminal edge 13, and is folded over onto the first fold layer 11. In the region of the two fold layers 11 and 12, the layer thickness of the separator layer 2 is thus in principle tripled compared to the layer thickness of the first metallic layer. However, the second fold layer 12 has an embossed corrugated structure 16, which has parallel beads running parallel to the folded edge 15 and the terminal edge 13 from one side of the fold layer 12 to the opposite side of the fold layer 12. This additional corrugated structure 16 further modifies the increase in thickness of the separator plate 2 caused by the fold layers 11 and 12, so that increases in thickness of the separator plate 2 deviating from multiples of the layer thickness are also possible.

As further embodiments of the corrugated structure 16, the corrugated structure 16 may also have trapezoidal cross-sections.

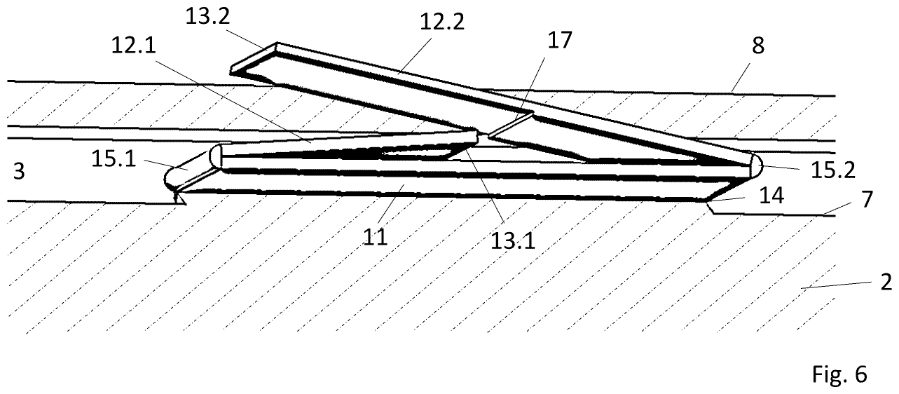

FIG. 6 shows an oblique view of a deformation limiter as in FIG. 4, whereby the fold layer 11 is not yet completely folded over onto the metallic layer 2 for better visualization. In contrast to FIG. 4, the second fold layer 12.2 protrudes beyond the first fold layer 12.1. The thickness of the second fold layer 12.2 is reduced in the region where the first fold layer 11, the second fold layer 12.1 and the third fold layer 12.2 lie on top of each other. This is achieved by providing a step 17 on the side of the second fold layer 12.2 facing the fold layer 11, at which the thickness of the fold layer 12.2 is reduced starting from the folded edge 15.2 to the terminal edge 13.2 of the second fold layer 12.2. This also makes it possible to produce non-integer multiples of the original layer thickness of the metallic layer of the separator plate 2 in the region of the deformation limiter.

1. A component of an electrochemical cell, comprising at least one first metallic layer, wherein the at least one first metallic layer, adjacent to at least one free edge of the at least one first metallic layer, is at least in sections folded over on itself one or more times thereby forming one or more fold layers, thereby increasing a thickness of the component by one or more than one layer thickness of the at least one first metallic layer.

2. The component of the electrochemical cell according to claim 1, wherein the at least one first metallic layer is folded over on itself several times, in that the at least one first metallic layer is folded over on itself a first time, thereby forming a first fold layer of the one or more fold layers, and the first fold layer is folded over on itself, thereby forming a second fold layer of the one or more fold layers.

3. The component of the electrochemical cell according to claim 1, wherein the at least one first metallic layer is folded over on itself several times in that a first region of the at least one first metallic layer is folded over on itself, thereby forming a first fold layer of the one or more fold layers on a first surface of the at least one first metallic layer, and a second region of the at least one first metallic layer is folded over on itself, thereby forming a second fold layer of the one or more fold layers on the first surface or a second surface of the at least one first metallic layer that faces away from the first surface, wherein the first fold layer and the second fold layer are folded over on themselves in a top view of the first surface of the at least one first metallic layer at least in a region of the at least one first metallic layer.

4. The component according to claim 1, wherein the at least one first metallic layer is folded over several times, thereby forming at least two fold layers of the one or more fold layers, wherein directions of extension of folded edges of the at least two fold layers extend parallel or perpendicular to one another.

5. The component according to claim 1, wherein the at least one first metallic layer is folded over several times, thereby forming at least two fold layers, the at least two fold layers being arranged on the same surface of the at least one first metallic layer or on opposite surfaces of the at least one first metallic layer.

6. The component according to claim 1, wherein at least one fold layers of the one or more fold layers has embossed structures at least in certain regions.

7. The component according to claim 6, wherein at least one fold layer of the one or more fold layers, which has embossed structures, has, at least in sections, a wave-shaped or trapezoidal cross-section in a region of the embossed structures.

8. The component according to claim 1, wherein at least one fold layer of the one or more fold layers has a smaller layer thickness, at least in a region in which the at least one fold layer is directly adjacent to another fold layer of the one or more fold layers and arranged above or below the another fold layer, than a layer thickness outside the region.

9. The component according to claim 1, wherein the at least one first metallic layer or a further layer adjacent to the at least one first metallic layer has an elastic element which is arranged adjacent to a folded-over section when viewed from above the at least one first metallic layer.

10. The component according to claim 1, wherein the at least one free edge is a circumferential edge of a through-opening in the at least one first metallic layer or is an outer edge of the at least one first metallic layer.

11. The component according to claim 1, wherein the at least one first metallic layer is provided with a coating on one, several, or all surfaces of the at least one first metallic layer in a region of the component that is thickened by folding over the at least one first metallic layer.

12. The component according to claim 11, wherein the coating comprises one, several, or all of the materials in a group consisting of an elastomer, metals, metal oxides, nitrides, carbides and graphite.

13. A bipolar plate for electrochemical cells comprising the component according to claim 1.

14. The bipolar plate according to claim 13, further comprising a second metallic layer which is adjacent to and in contact with the at least one first metallic layer, wherein the second metallic layer has an elastic element that is adjacent to a folded-over section in the at least one first metallic layer when viewed from above the plane of the at least one first metallic layer, wherein the elastic element is an elastomer or an embossed structure.

15. An electrochemical cell, comprising the bipolar plate according to claim 13 and a flat membrane electrode assembly (MEA).

16. An electrochemical system, comprising a stack of electrochemical cells according to claim 15, which are arranged adjacent to one another and sealed off from one another parallel to the plane of the at least one first metallic layer.

17. The component according to claim 9, wherein the elastic element is an elastomer or an embossed structure.

18. The component according to claim 17, wherein the elastic element is a sealing bead.

19. The component according to claim 10, wherein the through-opening supplies or discharges a medium.

20. The bipolar plate according to claim 14, wherein the elastic element is a sealing bead.
